(19) United States
(12) Patent Application Publication
(10) Pub. No.: US 2003/0230081 A1
(43) Pub. Date: Dec. 18, 2003

(54) Exhaust performance chamber

(76) Inventor: Donald Jerome Waller, Long Beach, CA (US)

Correspondence Address: Curt Harrington, Suite 250, 6300 State University Drive, Long Beach, CA, 90815, US

(21) Appl. No.: 10/172,482

(22) Filed: Jun. 14, 2002

(51) Int. Cl. F02B 27/02

(52) U.S. Cl. 60/312

(57) ABSTRACT

An exhaust performance chamber is provided as in interstitial interfitting member or housing which mates between the conventional exhaust manifold exit and tail pipe entrance. The engine typically utilized with the exhaust performance chamber is a high frequency very small engine having a speed of about 30,000 to 35,000 revolutions per minute. Interposing the exhaust performance chamber into a conventional exhaust stream having a manifold and exhaust pipe connection requires an additional seal and perhaps a lengthened spring to complete the exhaust train starting from a standard configuration. The modular property facilitates multiple change-outs to determine the best configuration for a given engine and terrain. In a first embodiment, a chamber is provided ahead of an orifice. In a second embodiment, an expansion chamber is formed. The use of the performance chamber has been shown to increase fuel efficiency and increase low end or initial movement power performance.

### FIELD OF THE INVENTION

The present invention relates to improvements in exhaust technology for internal combustion engines and more particularly to improvements in exhaust technology for small, high speed engines which result in improved efficiency and which facilitate interposition between the engine and final exhaust pipe and quick interchange.

### BACKGROUND OF THE INVENTION

The competitive remote controlled car field utilizes both one-eighth scale, one-tenth scale, and other remotely controlled cars having hydrocarbon powered engines. The engines are typically two cycle and operate with a fuel utilizing both conventional hydrocarbon fuel and mixed with a nitro based fuel. The angular speed of the engines can vary from 30,000 to 35,000 revolutions per minute. The combination of high speed, the resulting high frequency sound propagating through the exhaust stream and the relative lack of control available with glow plug ignition can make performance improvement possibilities problematic if not impossible.

Low end power, or torque at low revolutions per minute is a problem with the above types of engines. The specific source of the problem has not been previously documented, and what would appear to be the more obvious possible solutions of modifying the engine design, or providing additional mechanical components have not materialized. In some cases, competitive racing will not allow complex solutions, and in other cases a complex solution may compromise other aspects of performance.

Different sized engines and engine exhaust systems have combined with competitive component standardization to tend to restrict exhaust final systems simply to those which have been made available regardless of performance. Improved performance is typically had by a complete re-engineering of the entire exhaust system which has enough complexity that a change in one area would either result in repetitive production of the exhaust system, or degradation of performance by attempting to change two or more aspects at the same time.

What is therefore needed is a simple device which has the ability to improve performance in a high frequency mechanical system and which results in minimum changes to the overall system construct. The needed solution should invite performance optimization by enabling quick connection and disconnection by interposition within the exhaust train.

### SUMMARY OF THE INVENTION

An exhaust performance chamber is provided as in interstitial interfitting member which mates between the conventional exhaust manifold exit and tail pipe entrance. The chamber requires an additional seal and perhaps a lengthened spring to complete the exhaust train starting from a standard configuration. In a first embodiment, a chamber is provided ahead of an orifice. In a second embodiment, an expansion chamber is formed. The use of the performance chamber has been shown to increase fuel efficiency and increase low end or initial movement power performance.

### BRIEF DESCRIPTION OF THE DRAWINGS

The invention, its configuration, construction, and operation will be best further described in the following detailed description, taken in conjunction with the accompanying drawings in which:

FIG. 1 is a cross sectional view of a manifold-seal-exhaust pipe combination and illustrating the solid view insertion of the performance chamber member an interfitting addition with additional seal;

FIG. 2 is an end view of the performance chamber of FIG. 1 and illustrating internal and external details and a dimension identification key;

FIG. 3 is a side sectional view of the performance chamber of FIG. 2, taken along line 3-3 and illustrating both further internal details and a further set of dimension identification keys;

FIG. 4 is an end view of a second embodiment of a performance chamber and illustrating internal and external details and a dimension identification key; and

FIG. 5 is a side sectional view of the performance chamber of FIG. 4, taken along line 5-5 and illustrating both further internal details and a further set of dimension identification keys.

### DETAILED DESCRIPTION OF THE PREFERRED EMBODIMENT

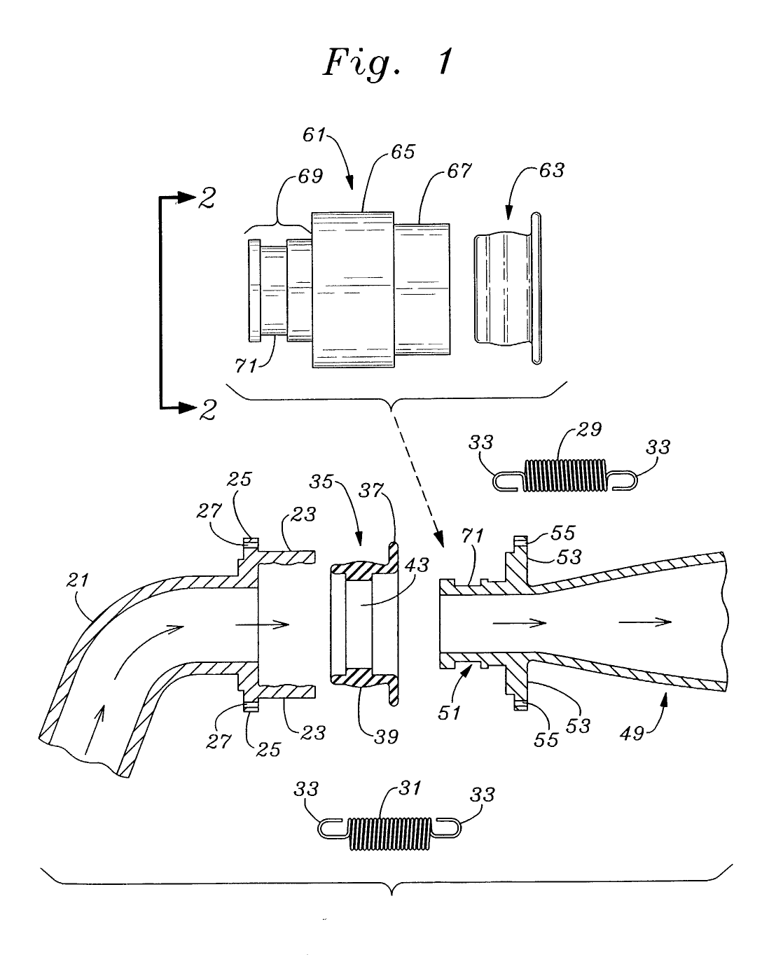

The description and operation of the performance chamber invention will be best initiated with reference to FIG. 1 which illustrates a conventional exhaust manifold 21 in which flow is occurring as per the internal arrows. The exhaust manifold 21 is connected to an engine (not shown), and terminates at a fitting 23. Fitting 23 may have a flange 25 with spring hook bores 27 located at points near the periphery of flange 25. One or more springs 29 and 31 can be utilized with the spring hook bores 27, as will be shown. Each of the springs 29 and 31 have hook ends 33.

A seal member 35 is shown has having a rim portion 37, a cylindrical portion 39 on its external surface, and a cylindrical internal surface 41 interrupted by a radial land 43. To the right of the seal member 35 is an exhaust pipe member 49 having a male fitting 51 and a flange 53 having spring hook bores 55 which are typically engaged by the other hook ends 33 of the hooks 29 and 31 to provide an urging force of flange 25 toward flange 53 to secure the seal member 35 in place.

The components thus far described generally encompass a straight exhaust manifold 21 to exhaust pipe member 49 connection. Above in FIG. 1 with an arrow indicating an insertion point between the exhaust pipe 49 and the seal member 35 is an exhaust performance chamber 61 having an interfitting configuration for fitting which enables it to serially fit between exhaust pipe 49 and the seal member 35 with the addition of an additional seal member 63.

The external features of the exhaust performance chamber 61 include a main body 65, a female fitting 67 for admitting a cylindrical portion 39 of one of the seal members 35 or 63, and a male fitting 69 for insertion into the internal area of the seal members 35 or 63.

The male fitting forward of the flange 53 or main body 65 is the same and includes a main radial groove 71. Main radial groove 71 is displaced from the flange 53 in the case of exhaust pipe member 49, or is displaced from the main body 65, in the case of the exhaust performance chamber 61. As can be seen, the use of exhaust performance chamber 61 is simply had by unhooking the traditional exhaust manifold 21 from the exhaust pipe member 49 and inserting the exhaust performance chamber 61 with its additional seal member 63 in between. This configuration facilitates the user optimization of performance by enabling different sized exhaust performance chambers 61 to be inserted and removed under test conditions. It also facilitates the use of multiple exhaust performance chambers 61 for different engine loading conditions. For competitive racing, these conditions might include the speed of the track, the type of traction available and other factors.

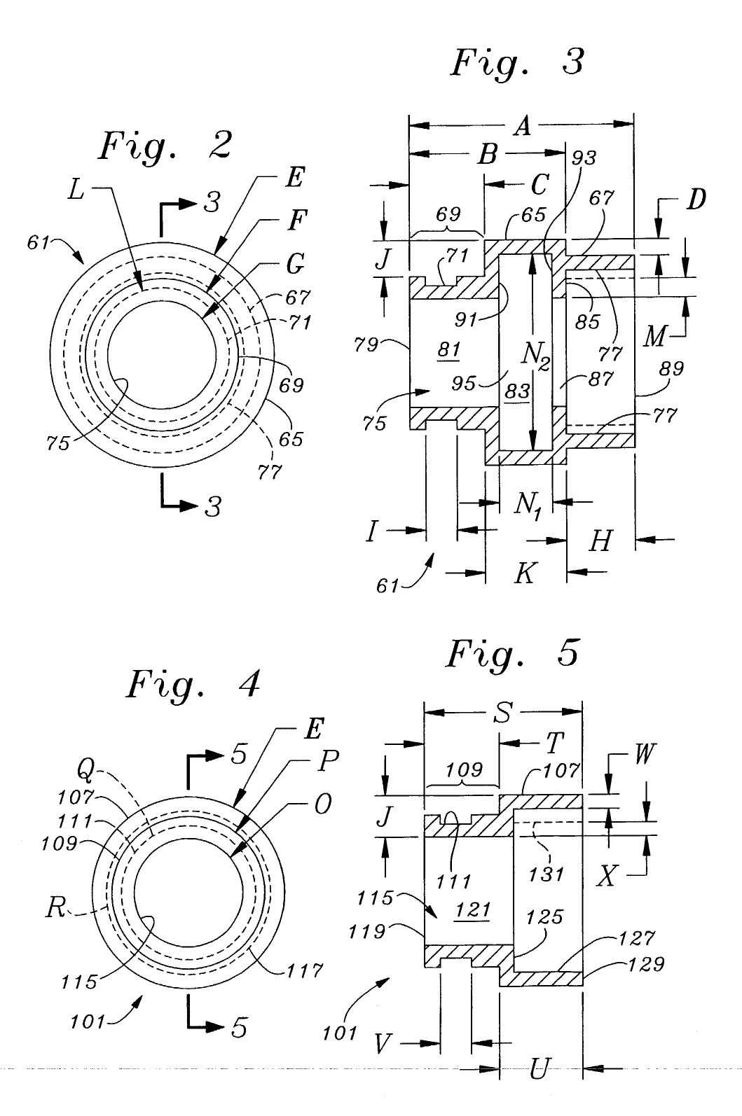

Referring to FIG. 2, a view taken from line 2-2 illustrates features seen in FIG. 1 and more. Exhaust performance chamber 61 is also seen as having a through opening 75 having a diameter “G” of about 0.532 inches. The outer diameter “F” of the male fitting 69 is about 0.748 inches. The outer diameter “L” of the main radial groove 71 is 0.669 inches. The overall diameter “E” of the main body 65 is about 1.127 inches. Also seen is an internal surface 77 of the female fitting 67 shown in dashed line format, and which will subsequently be shown in greater detail.

Referring to FIG. 3, further detail is shown in a cross sectional view. From the through opening 75, the exhaust performance chamber 61 is seen as having a male end 79, leading into a cylindrical inlet chamber 81. Cylindrical inlet chamber 81 leads to a main chamber 83. Main chamber 83 is also cylindrical, but need not be. The dimensions of the main chamber 83 include a dimension “N1” which represents an axial length of about 0.276 inches. Main chamber 83 has a diameter shown with the dimension “N2” of about 0.984 inches. Adjacent the main chamber 83, opposite the cylindrical inlet chamber 81, is an orifice 85 having an opening 87 which may also be known as an orifice size. The embodiment shown in FIGS. 2 and 3, for exhaust performance chamber 61, the opening 87 orifice size is about 0.532 inches, matching the dimension “G” of the through opening 75 of the male fitting 69. Adjacent the side of the orifice 85 opposite from the main chamber 83 is the internal surface 77. The internal surface 77 extends to a female end 89.

Further letter style dimension markers are given. The overall length “A” of the exhaust performance chamber 61 is about 1.102 inches. The combined length of the male fitting 69 and main body 65, dimension “B” is about 0.768 inches with the length of the male fitting 69 indicated as dimension “C” as about 0.374 inches. The main body radius above the female fitting 67 is indicated as dimension “D” 0.091 inches. The axial length of the female fitting 67 indicated as dimension “H” and is about 0.334 inches. The width of the main radial groove 71 is indicated as dimension “I” and is about 0.157 inches. The difference in the radius of the male fitting 69 with respect to the radius of the main body 65 is indicated as dimension “J” and is about 0.2395 inches. The axial length of the main body is indicated by dimension “K” which is about 0.394 inches.

Shown within and adjacent the internal surface 77 of the female fitting is a pair of dashed lines which represent the innermost diameter of the male fitting 51 of the exhaust pipe member 49. This defines the amount of expansion along the axial flow direction which is available, and is shown by the dimension “M” and is about 0.020 inches. Also seen are radial surfaces 91 and 93, which along with cylindrical surface 95 defines the enclosure of main chamber 83.

Referring to FIG. 4, an end view of a second embodiment of the performance exhaust chamber of the invention is seen from much the same position as the embodiment of FIG. 2. An exhaust performance chamber 101 provides an expansion but without the orifice 85 seen in FIG. 3. External features seen include a female fitting 107, and a male fitting 109. Male fitting 109 has a main radial groove 111. A through opening 115 can be seen. The female fitting 107 has an internal surface 117.

The exhaust performance chamber 101 through opening 115 has a diameter “0” of about 0.532 inches. The outer diameter “P” of the male fitting 109 is about 0.748 inches. The outer diameter “Q” of the main radial groove 111 is 0.669 inches. The overall diameter “R” of the female fitting 107 shown in dashed line format, is about 1.127 inches.

Referring to FIG. 5, further detail is shown in a cross sectional view. From the through opening 115, the exhaust performance chamber 101 is seen as having a male end 119, leading into a cylindrical inlet chamber 121. Cylindrical inlet chamber 121 leads directly to a radial surface 125. The radial surface 125 leads to an internal surface 127 of the female fitting 107. The internal surface 127 extends to a female end 129.

Further letter style dimension markers are given. The overall length “S” of the exhaust performance chamber 101 is about 0.767 inches. The length of the male fitting 109 is seen at dimension “T” and is about 0.374 inches. The length of the female fitting 107 indicated as dimension “U” as about 0.393 inches. The width of the main radial groove 111 is indicated as dimension “V” and is about 0.157 inches. The thickness of the female fitting 107 is indicated by dimension “W” which is about 0.0715 inches. a dashed line 131 represents the extent to which a male fitting would cover the outer area of the radial surface 125 and leaves a radial height dimension indicated by the letter “X” of about 0.02 inches. This height difference, or amount of the radial surface 125 left represents the expansion available by use of the exhaust performance chamber 101.

Tests were performed which show improved run times for a given fuel supply indicating more efficient fuel consumption, as well as more bottom end power or torque at low engine revolutions per minute. The test was performed on four different engines, which are commercially available as R.B. concept, JP Engine, OS MAX01, and OFNA-Picco G-1. These engines will be designated with the letter combinations RB, JP, OS, AND OFNA. All test engines used the 9886 (0.086) one piece tail pipe. All engines utilized a 30% nitro fuel. Each engine was run with its own different type one-eighth scale four wheel drive remote control car.

The engine size in all cases was the 0.21 cubic inch, 3.5 cc volume displacement glow plug type engine. Each car had a different driver who was told nothing about the details of the test or the exhaust performance chamber which was added to the cars' exhaust system. a baseline run appears in Table 1 in which no exhaust performance chamber was utilized.

TABLE 1

| Engine | Run Time | Observed Bottom End Power |
|---|---|---|
| RB | 6:30 | WEAK |
| JP | 6:00 | WEAK |
| OS | 5:39 | WEAK |
| OFNA | 7:12 | WEAK |

Three different test parts of the exhaust performance chamber 61 were constructed having different volume main chambers 83. Volumes of 2723 mm³ (0.167 in³), 1963 mm³ (0.120 in³), and 3434 mm³ (0.210 in³) were tried. The 3434 mm³ (0.210 in³) size generally appeared to show more promise and was selected as the test sample.

A series of orifice sizes were selected for inclusion within the test sample, including orifice diameters of 13.15 mm (0.518 inches), 13.30 mm (0.524 inches), 13.52 mm (0.532 inches), 13.65 mm (0.536 inches), 13.80 mm (0.543 inches), 13.90 mm (0.547 inches), and 14.00 mm (0.591 inches). Of the above, only the 13.15 mm (0.518 inches), 13.30 mm (0.524 inches), 13.52 mm (0.532 inches), 13.65 mm (0.536 inches) categories of orifice within the selected test sample exhibited significant improvement. The results are shown in Table 2:

TABLE 2

| | | | Observed Bottom |
|---|---|---|---|
| Orifice | Engine | Run Time | End Power |
| 13.15 | RB | 8:10 | WEAK |
| | JP | 7:50 | WEAK |
| | OS | 8:30 | WEAK |
| | OFNA | 9:05 | WEAK |
| 13.30 | RB | 7:52 | FAIR |
| | JP | 7:40 | FAIR |
| | OS | 7:59 | FAIR |
| | OFNA | 8:40 | FAIR |
| 13.52 | RB | 7:42 | GOOD |
| | JP | 7:28 | GOOD |
| | OS | 7:54 | GOOD |
| | OFNA | 8:36 | GOOD |
| 13.65 | RB | 7:10 | GOOD |
| | JP | 6:51 | GOOD |
| | OS | 6:31 | GOOD |
| | OFNA | 7:40 | GOOD |

In addition to low end power, an engine temperature test was performed. In the case for no exhaust performance chamber, the engine temperatures rose quickly between the following maximums and minimums. RB, from 240° to 270°;JP, from 230° to 265°; OS, from 230° to 255°; and OFNA, from 230° to 255°. The temperature ranges which resulted from the use of various orifice sizes are seen in Table 3:

TABLE 2

| | | Start | Finish |
|---|---|---|---|
| Orifice | Engine | Temperature | Temperature |
| 13.15 | RB | 242° | 267° |
| | JP | 229° | 267° |
| | OS | 225° | 254° |
| | OFNA | 232° | 250° |
| 13.30 | RB | 246° | 263° |
| | JP | 234° | 269° |
| | OS | 228° | 257° |
| | OFNA | 226° | 251° |
| 13.52 | RB | 242° | 269° |
| | JP | 229° | 268° |
| | OS | 230° | 258° |
| | OFNA | 227° | 254° |
| 13.65 | RB | 240° | 259° |
| | JP | 230° | 250° |
| | OS | 226° | 246° |
| | OFNA | 225° | 240° |

The results show that for nearly all tests, the maximum temperature or ending temperature for the test was slightly higher than for the baseline case (no exhaust performance chamber).

The orifice size of 13.52 mm (0.532 inches) in diameter was picked as the most acceptable to use for general purposes, although certain track or surface conditions could take advantage of the other orifice sizes.

In comparing the ratio of chamber volume to orifice size for the 3434 mm³ chamber, a series of ratios result. a series of ratios of volume to orifice size of from about 261 to about 245 is computed, with the most desirable rations of from about 261 to about 251.6. The exhaust performance chamber of FIG. 3, as an example had an axial length of 0.276 inches and a diameter of about 0.984 inches to yield the 3434 mm³ (0.210 in³) chamber.

As shown in FIG. 3, the ratio of diameter “N2” to axial length “N1” is about 3.56. As is shown in FIG. 5, the expansion from the 0.532 inch diameter cylindrical inlet chamber 121 to an effective enlargement of diameter “X” dimension of 0.02 to a new effective diameter of 0.572 translates to a diameter ratio of 1.075, and an area ratio of area of cylindrical inlet chamber 121 of 0.222 in² to a ratio of effective area of about 0.257 in² to form a ratio of 1.157, although the ratio may vary from about ten percent on either side to yield a ratio of from about 1.04 to about 1.29. The characterization in size to achieve performance is believed to be the best way to identify the complex interactions of exhaust flow for engines having such high frequency.

While the present invention has been described in terms of an exhaust performance chamber, and more particularly to an interstitially placeable chamber for interfitting between an exhaust manifold and tail pipe, and in particular structures which can accomplish performance enhancing improvements by treating the exhaust flow stream, the principles contained therein are applicable to other instruments, devices, processes and structures in which performance enhancement is to be accomplished particularly in high frequency engines.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. An exhaust performance chamber for use in an exhaust stream of an internal combustion engine comprising:
a housing having an entrance, a main chamber in communication with said entrance and having a volume, and an exit orifice in communication with said main chamber and having an area and wherein a ratio of said volume to said area is from about 261 to about 245.

2. The exhaust performance chamber as recited in claim 1 wherein said main chamber is cylindrically shaped.

3. The exhaust performance chamber as recited in claim 2 wherein said cylindrically shaped main chamber has a diameter and an axial length and wherein a ratio of diameter to axial length for said cylindrically shaped main chamber is about 3.56.

4. The exhaust performance chamber as recited in claim 1 wherein said housing further includes a male fitting adjacent said entrance and a female fitting adjacent said orifice for interposing said exhaust performance chamber in an exhaust stream.

5. The exhaust performance chamber as recited in claim 1 wherein said ratio of said volume to said area is more preferably from about 261 to about 251.6.

6. An exhaust performance chamber for use in an exhaust stream of an internal combustion engine comprising:
a housing having a male fitting having an entrance, a main chamber having a volume in communication with said entrance and an exit orifice having an opening in communication with said main chamber and a female fitting having an exit in communication with said orifice opening.

7. The exhaust performance chamber as recited in claim 5 and further comprising a seal member fittable both within said female fitting and over said male fitting.

8. An exhaust performance chamber for use in an exhaust stream of a high frequency internal combustion engine comprising:
a housing having an entrance having a cylindrical inlet chamber, and an outlet for interfitting with a first male fitting having an inlet opening larger than said cylindrical inlet chamber to form an expansion having an area ratio of inlet opening to an area of said cylindrical inlet chamber of from about 1.04 to about 1.29.

9. The exhaust performance chamber as recited in claim 8 wherein said expansion having an area ratio of inlet opening to an area of said cylindrical inlet chamber is about 1.157.

10. The exhaust performance chamber as recited in claim 9 wherein said cylindrical inlet chamber of said housing entrance is part of a second male fitting so that said housing can mate between a conventional exhaust manifold exit having a female fitting and a tail pipe entrance having said first male fitting for interposing said exhaust performance chamber in an exhaust stream.

11. The exhaust performance chamber as recited in claim 8 wherein said housing entrance cylindrical inlet has a first diameter and wherein said first male fitting having an inlet has a second diameter and wherein said ratio of said second diameter to said first diameter is about 1.075.
